(19) United States
(12) Patent Application Publication
(10) Pub. No.: US 2002/0194327 A1
(43) Pub. Date: Dec. 19, 2002

(54) Method for sensing the status of a client from a server

(75) Inventors: Frank J. DeGilio, Poughkeepsie, NY (US); Joseph L. Temple III, Hurley, NY (US)

Correspondence Address: Philmore H. Colburn II, Cantor Colburn LLP, 55 Griffin Road South, Bloomfield, CT, 06002, US

(73) Assignee: INTERNATIONAL BUSINESS MACHINES CORPORATION, ARMOND, NY

(21) Appl. No.: 09/881,325

(22) Filed: Jun. 14, 2001

(51) Int. Cl. G06F 15/173; G06F 15/16

(52) U.S. Cl. 709/224; 709/203

(57) ABSTRACT

An exemplary embodiment of the invention relates to a method implemented in a web server whereby extra and/or null byte streams are periodically sent to a browser during long, costly queries or searches, and the standard error response received from that browser (resulting from abandonment of the search) triggers abortion of the long operation. In one embodiment, the server periodically sends null messages to the browser in order to detect its presence. If a “not connected” error message returns, the server aborts the operation, freeing up resources. A second embodiment includes sending advertising and/or entertaining byte streams to the browser instead of null messages. In a third embodiment, a separate window is opened at the browser for delivery of the information and null messages are sent to it, allowing the user to ‘click off’ on the original browser during the wait period.

### BACKGROUND

This invention relates generally to computer network-based client/server activities and more particularly, the present invention relates to a method for sensing the status of a client from a server by delaying page closure.

Utilization of the World Wide Web, i.e., a global hypermedia document that resides on and stretches across most of the Internet, commonly involves a web browser interface program, such as Netscape Navigator(™), to access hypermedia documents, commonly referred to as web pages. Sites on the Internet are chosen by a user usually by entering a site address, i.e., a URL (uniform resource locator), or by selecting a link on a displayed web page of a current site. A user on a client computer system addresses a web site hosted by a remote server system. The remote server accesses the chosen web site by locating a local file storing the data for the addressed web site. The remote server then transfers the data for the website to the client system. With the World Wide Web utilizing a standard protocol, e.g., HyperText Transfer Protocol (HTTP), for transferring information across the Internet and web software following this protocol, information transfer occurs between the remote server and client system.

During the process of requesting a site and transferring data, the client system waits. Unfortunately when the site being accessed contains large image files, the wait for data transfer can become excessive. Also, in certain situations, such as international web sites or sites with server problems, data transfer is slow. The time wasted waiting is not only inconvenient to the user, but may be costly for those situations in which users pay for use of the Internet based on the length of connection time.

Usual attempts to end the delay associated with slow data transfers involve the selection of a stop transfer function, e.g., selection of stop button icon in the web browser. While the delay is ended, the selection of the stop function completely ends data transfer, thus stopping not only a large image transfer but the transfer of text information in the information stream from the server as well. Alternatively, a user at a client system is free to ‘click off’ or move to another web site without notifying the server. ‘Clicking off’ refers to the action taken by a user which changes the contents of the current browser window. For example, a user ‘clicks’ off by typing in a new address in the address bar, selecting the ‘back’ button on the browser, or by clicking on a new hyperlink in the current window. When a user at the client system decides to do this, the web server site not only loses that user's attention, but also continues to expend considerable resources which could otherwise be provided to others. It is likely that circumstances which cause some clients to ‘click off’ can lead to a great deal of resources tied up on dead queries or searches, causing further delays which result in more users clicking off. While it is desirable to avoid all click offs by providing fast responses to all requests, this is difficult, if not impossible to achieve in the realm of ad hoc queries and searches.

Because of the disadvantages and shortcomings described above, it is desirable to know when a user clicks off so that ‘dead’ searches can be aborted at the server level, freeing up valuable resources. Others have solved this by creating a ‘session’ with the web browser or running specific code at the client. However, these solutions bring with them the overhead of either session management at the server or require customized proprietary code at the client, neither of which is desirable.

### BRIEF SUMMARY

The foregoing problems and shortcomings of the prior art are addressed by the present invention which provides a method implemented in a server whereby extra and/or null byte streams are periodically sent to a browser during long, costly queries or searches, and the standard error response received from that browser (resulting from abandonment of the search) triggers abortion of the long operation. In one embodiment, the server periodically sends null messages to the browser in order to detect its presence. If the standard “not connected” error message returns, the server aborts the long running operation, freeing up resources.

In a second embodiment, standard advertising and/or entertaining (“eye candy”) byte streams are sent to the browser instead of null messages. The terms ‘messages’ and byte streams are used interchangeably throughout this description. These require more overhead to send but can be used to derive either business value or advertising revenue.

In yet another embodiment, a separate window is opened at the browser for delivery of the search or query information and null messages are sent to it, allowing the user to ‘click off’ on the original browser window while waiting for the information. The use of a second window is a technique which allows for a “background” search or link, but this just reduces the incidences of ‘clicking off’, since the user can close the new window at any time.

The above embodiments can be accomplished without any dependence on special functions at the client or in the clients browser, and also without establishing any session state. There is also no dependence on the content of the byte streams sent (they may even be null) on the operation of the method in the server, since it uses standard error messages to abort dead operations.

### BRIEF DESCRIPTION OF THE DRAWINGS

Referring now to the drawings wherein like elements are numbered alike in the several FIGURES:

FIG. 1 is a block diagram illustrating an exemplary network system upon which the invention is implemented;

FIG. 2 is a flowchart describing the process of determining a web client's presence during a web search according to a first embodiment of the invention;

FIG. 3 is a flowchart describing the process of determining a web client's presence during a web search according to a second embodiment of the invention; and

FIG. 4 is a flowchart describing the process of determining a web client's presence during a web search according to a third embodiment of the invention.

### DETAILED DESCRIPTION OF THE PREFERRED EMBODIMENT

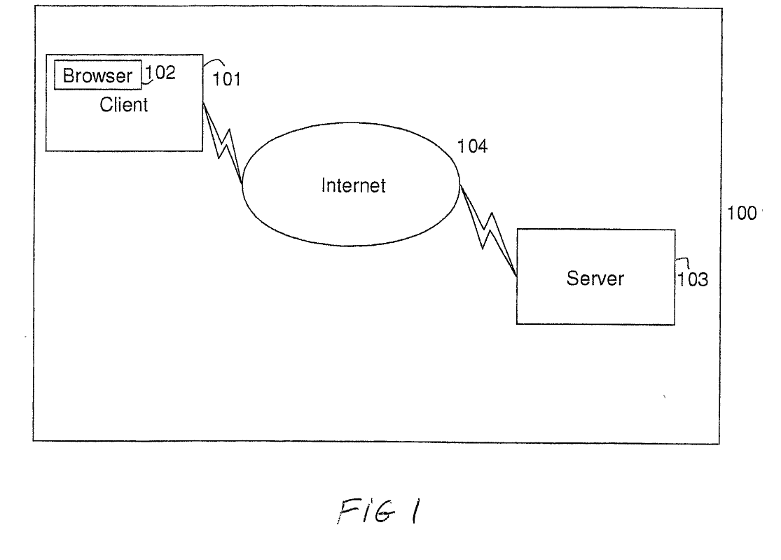

In an exemplary embodiment, a method for sensing the status of a web client from a web server is implemented via a communications network such as that shown in FIG. 1. The invention is described with reference to world wide web pages. It is understood that the invention may be applied to any client/server-based communications network and is not limited to the world wide web. Referring to FIG. 1, an illustration of the basic elements constituting a communications network system 100 is depicted. Network system 100 includes client 101 executing a standard web browser 102. Client 101 is in communication with server 103 via the Internet. It will be understood by those skilled in the art that while the following discusses a single client and browser connected via the Internet to a single server, multiple clients and multiple servers can be included within system 100 to achieve the advantages of the present invention. Likewise, the term “Internet” can mean any communications network, public or private, which allows transmission of standard browser/server protocol and thus, is not necessarily limited to the Internet itself. Client 101 and server 103 can communicate with one another utilizing the functionality provided by Hypertext Transfer Protocol (HTTP). The World Wide Web (WWW), includes all the servers adhering to this standard which are accessible to clients via universal resource locators. In particular, client 101 and server 103 may be coupled to one another via TCP/IP connections for high-capacity communication. Browser 102 establishes a connection with server 103 and presents information to the user at client 101. Server 103 executes corresponding server software which presents information to client 101 in the form of HTTP responses. HTTP responses correspond to WWW pages constructed from a Hypertext Markup Language (HTML) or other server-generated data.

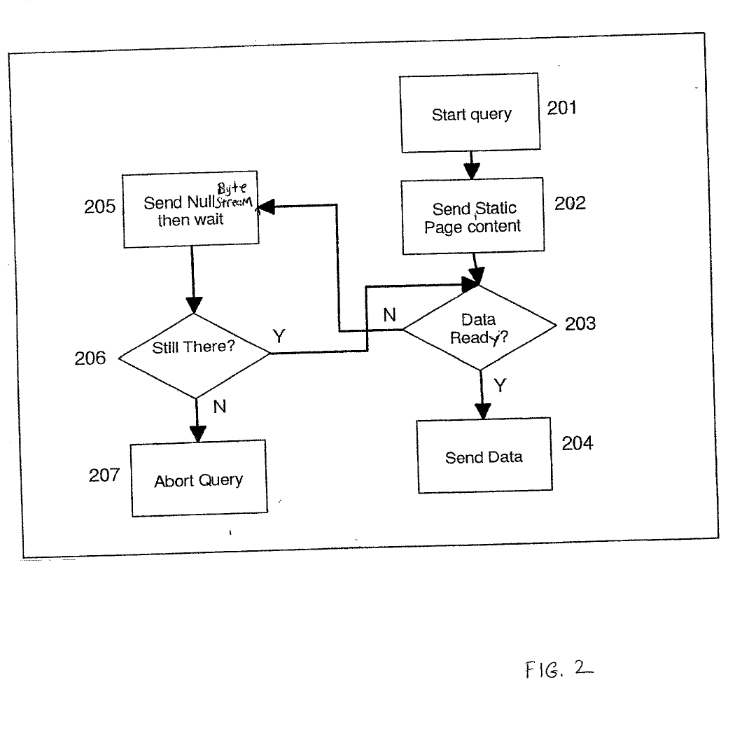

A user at client 101 makes a request through browser 102, which client 101 transmits over the Internet to server 103. Server 103 starts its search or query process and, upon determining that this is a “long” query, proceeds to execute a method as described in FIGS. 2 through 4 for determining whether browser 102 is still present and the data searched for is ready for transmission.

In a first embodiment, FIG. 2 illustrates the process employed by the invention to determine a browser's presence during a search. Client 101 initiates a query at step 201. Server 103 sends a static web page data at step 202 and then checks to see if the data is ready for transmission to client 101 at step 203. If so, server 103 sends the data at step 204; otherwise, a null message byte stream (BS) is sent followed by a waiting period at step 205. A static web page may include any response data indicating that server 103 is processing the search request (e.g., “please wait”, “search in progress”, “searching”). If an error response is returned indicating that client 101 is not present (206), the query is aborted at step 207, otherwise the process reverts to step 203.

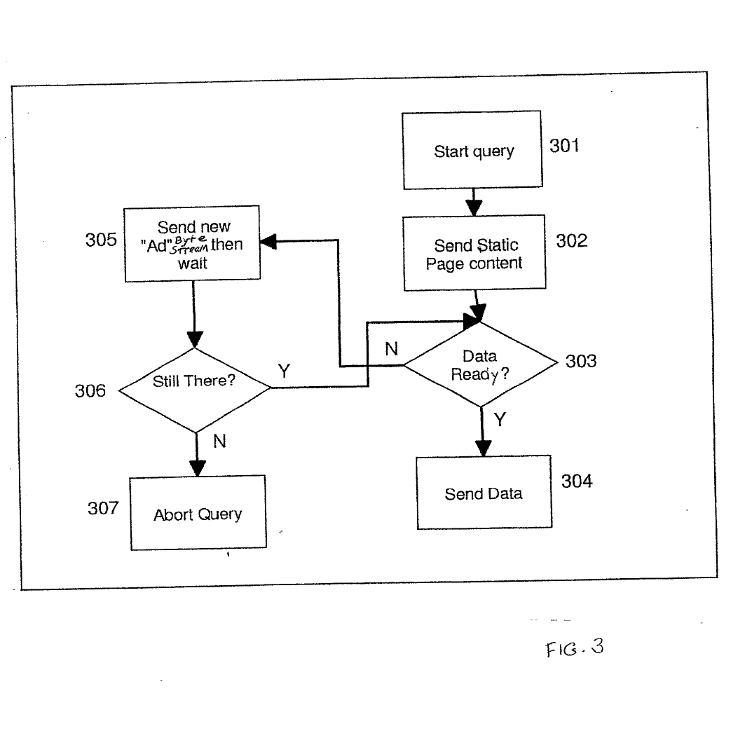

FIG. 3 illustrates a second embodiment of the invention whereby advertisement (‘ad’) byte streams (BSs) are sent by server 103 in lieu of the null byte streams described in FIG. 2. The ad byte streams may be any entertaining or interesting data or information which is intended to keep the interest of users such as the user at client 101, as well as to derive business value or revenue therefrom. Referring to FIG. 3, a query is initiated by client 101 at step 301. A static web page data is sent by server 103 to client 101 at step 302. Server 103 checks to see if the data searched for is ready for transmission at step 303. If so, server 103 sends the data to client 101 at step 304; otherwise, an updated ad byte stream (BS) or null message is sent, followed by a waiting period at step 305. If an error response is returned indicating that client 101 is no longer present (306), the query is aborted by server 103 at step 307, otherwise the process reverts to step 303. Thus, the second embodiment described above in FIG. 3 is similar to that described in the first embodiment of FIG. 2 with the exception that in the second embodiment specific information is sent to browser 102 instead of a null byte stream. Note that in either case the method for determining when to abort an operation is totally independent of the data (if any) sent to the client, depending solely on the normal acknowledgment or error message received from a standard browser such as browser 102 when sent a byte stream.

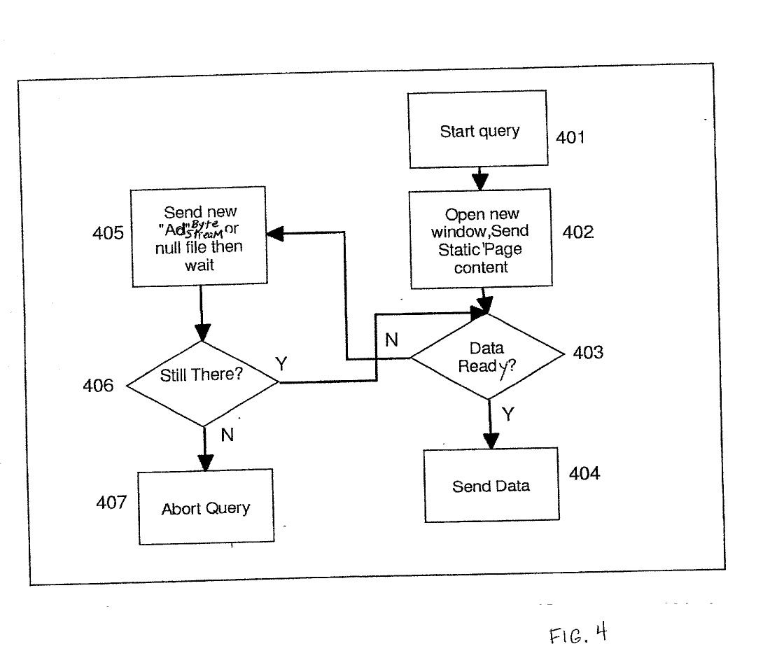

In a third embodiment, a new window can be opened at browser 102 before executing the method. Referring to FIG. 4, a query is initiated by client 101 at step 401. A new browser window at client 101 is opened and any static web page data is sent by server 103 at step 402. Server 103 checks to see if the data is ready for transmission at step 403. If so, it is sent to client 101 at step 404, otherwise a null message or ad byte stream is sent to the initial browser window at client 101, followed by a waiting period at step 405. If an error response is returned indicating that client 101 is not present (406), the query is aborted by server 103 at step 407, otherwise the process reverts back to step 403.

Note that in each of the three embodiments described above, there is a waiting period. The amount of wait time is a tunable parameter. It can be set as a timing loop or set up as a wake up signal from an interval timer. This is standard in any inter-system or interprocess interface, and those skilled in the art will recognize the tradeoffs involved. The method for waiting and/or tuning the timing or pacing of the loop has no effect on the present invention, which will work regardless of the method used to tune the rate at which ‘null’ or ‘ad’ byte streams are sent.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation.

1. A method for monitoring the presence of a client from a server via a communications network, comprising:
establishing a connection with said client via said communications network, wherein said server receives a request;
transmitting a static web page to a web browser of said web client related to said request;
determining whether data related to said request is ready for transmission to said web client;
transmitting said data to said client when said data is ready for transmission; and
transmitting a byte stream to said web client, when said data is not ready for transmission.

2. The method of claim 1, further comprising:
waiting for a response from said client subsequent to said transmitting said byte stream; and
if said response indicates said client is present:
determining whether said data related to said request is ready for transmission to said client, including:
transmitting said data to said client when said data is ready for transmission;
transmitting a byte stream to said client when said data is not ready for transmission; and
if said response indicates said client is not present:
aborting said request.

3. The method of claim 1, wherein said static page is transmitted to a second browser window of said client, said second browser window being opened subsequent to said request.

4. The method of claim 1, wherein said static page includes a response message relating to said request.

5. The method of claim 1 wherein said request includes a request whereby said data requested by said client has been located.

6. The method of claim 1 wherein said request includes a request that is in progress.

7. The method of claim 1, wherein said byte stream includes a null message.

8. The method of claim 1, wherein said byte stream includes an advertisement.

9. The method of claim 2 wherein said response includes an error code.

10. The method of claim 2 wherein said response indicates that said client is present.

11. A storage medium encoded with machine-readable computer program code for monitoring the presence of a web client from a server via a communications network, the storage medium including instructions for causing a computer to implement a method comprising:
establishing a connection with said client via said communications network, wherein said server receives a request;
transmitting a static web page to a web browser of said web client related to said request;
determining whether data related to said request is ready for transmission to said web client;
transmitting said data to said client when said data is ready for transmission; and
transmitting a byte stream to said web client, when said data is not ready for transmission.

12. The storage medium of claim 11, further comprising instructions for causing a computer to implement:
waiting for a response from said client subsequent to said transmitting said byte stream; and
if said response indicates said client is present:
determining whether said data related to said request is ready for transmission to said client, including:
transmitting said data to said client when said data is ready for transmission;
transmitting a byte stream to said client when said data is not ready for transmission; and
if said response indicates said client is not present:
aborting said request.

13. The storage medium of claim 11, wherein said static page is transmitted to a second browser window of said client, said second browser window being opened subsequent to said request.

14. The storage medium of claim 11, wherein said static page includes a response message relating to said request.

15. The storage medium of claim 11 wherein said request includes a request whereby said data requested by said client has been located.

16. The storage medium of claim 11 wherein said request includes a request that is in progress.

17. The storage medium of claim 11, wherein said byte stream includes a null message.

18. The storage medium of claim 11, wherein said byte stream includes an advertisement.

19. The storage medium of claim 12 wherein said response includes an error code.

20. The storage medium of claim 12 wherein said response indicates that said client is present.
